(19) United States
(12) Patent Application Publication
(10) Pub. No.: US 2008/0222421 A1
(43) Pub. Date: Sep. 11, 2008

(54) SIGNATURE INFORMATION PROCESSING METHOD, ITS PROGRAM AND INFORMATION PROCESSING APPARATUS

(76) Inventor: Kojiro NAKAYAMA, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/038,860

(22) Filed: Feb. 28, 2008

(30) Foreign Application Priority Data
Mar. 6, 2007 (JP) 2007-055679

(51) Int. Cl. H04L 9/00

(52) U.S. Cl. 713/176

(57) ABSTRACT

A signature information processing method using a relay apparatus which executes information processing on data containing signature information which is information concerning a signature is provided in order to prevent a signature from being invalidated. A signature information extraction unit conducts extraction processing to extract signature information from the data and store the signature information in the signature information storage unit. A message processing unit executes processing on the data. Thereafter, a signature information substitution unit conducts substitution processing to substitute signature information stored in the signature information storage unit for signature information contained in data obtained after execution of the processing.

### INCORPORATION BY REFERENCE

The present application claims priority from Japanese application JP2007-055679 filed on Mar. 6, 2007, the content of which is hereby incorporated by reference into this application.

### BACKGROUND OF THE INVENTION

The present invention relates to information security, and in particular to a technique for conducting processing on data provided with a digital signature.

There is the digital signature as a technique for assuring integrity of electronic data. The digital signature is electronic data which makes it possible to identify an implementor of signed data and detect falsification conducted on signed data after being provided with a signature. The digital signature is implemented by utilizing, for example, a public key encryption technique.

In recent years, a data form called XML (Extensible Markup Language) is drawing attention. The XML is one of markup languages having specifications opened to the public by a standardization association W3C (World Wide Web Consortium). The XML is widely utilized as a format when storing various data or as a format when exchanging data between different computers.

In a system integration technology called Web service, system linkage between computers in different environments is implemented by utilizing a message (SOAP message) in the XML form called SOAP (Simple Object Access Protocol) as a data exchange format. In this way, utilization of the XML in various scenes is being promoted. It is a very important subject to ensure security of the XML data.

There is “XML-Signature Syntax and Processing” (hereafter described as “XML-Signature) as specification concerning the security of the XML (see Donald Eastlake et al., “XML-Signature Syntax and Processing”, (online), Feb. 12, 2002, W3C, (retrieved on Dec. 8, 2006), Internet <URL:http://www.w3.org/TR/2002/REC-xmldsig-core-20020212/>). The XML-Signature is a specification which prescribes a syntax for describing information concerning the digital signature by using the XML and a processing method for the information. The specification is opened to the public by the W3C. In the XML-Signature, methods for signature on XML data and signature on other electronic data are prescribed.

There is a degree of freedom in the XML description method. Even if data mean the same contents, methods for representing the data are different in some cases. For example, both “<element></element>” and “<element/>” represent an empty element. Although they mean the same contents as XML data, they are data which are different from each other as the byte sequence. Since digital signature calculation is conducted on a byte sequence, a signature value calculated from “<element></element>” is different from a signature value calculated from “<element/>”. Since “<element></element>” and “<element/>” mean the same contents as XML data, however, it is desirable that the signature values are also the same.

In the XML-Signature, therefore, it is ordinary to conduct canonicalization processing on signed XML data before calculating the signature value. As an algorithm of canonicalization processing utilized at the time of XML signature, there is, for example, Exclusive XML Canonicalization (see John Boyer et al., “Exclusive XML Canonicalization”, (online), Jul. 18, 2002, W3C, (retrieved on Dec. 8, 2006), Internet <URL:http://www.w3.org/TR/2002/REC-xml-exc-c14n-20020718/>). If canonicalization is conducted by using Exclusive XML Canonicalization, unification to a form in which all description of empty elements is not omitted is conducted. In other words, if canonicalization is conducted by using Exclusive XML Canonicalization on element “<element/>”, element “<element></element>” is obtained as a result. Even if description methods are different, it becomes possible to obtain the same signature value from data which mean the same contents by thus conducting canonicalization processing on signed data before calculating a signature value in a computer which provides a signature and a computer which verifies the signature.

When conducting processing on data (for example, XML data) provided with a signature, the form of the data (for example, XML data) changes and consequently the signature is invalidated in some cases. For example, it is supposed that a signature apparatus 1510 transmits XML data provided with a signature to a verification apparatus 1530 via a relay apparatus 1520 and signature verification is conducted in the verification apparatus 1530 as in an example shown in FIG. 15. Hereafter, XML data exchanged between apparatuses is referred to as message as well.

First, in the example shown in FIG. 15, the signature apparatus 1510 provides a message with a signature (step S1501). Thereafter, the signature apparatus 1510 transmits the message provided with the signature to the relay apparatus 1520 (step S1502). The relay apparatus 1520 receives the message (step S1503), and conducts some processing on the received message (step S1504). The relay apparatus 1520 transmits the processed message to the verification apparatus 1530 (step S1505). The verification apparatus 1530 receives the message (step S1506), and conducts verification on the signature contained in the received message (step S1507).

If the form of the XML data changes in the processing conducted in the relay apparatus 1520, i.e., at the step S1504, then the signature might be invalidated even if the meaning of the XML data does not change. If processing which invalidates the signature is conducted in the processing conducted in the relay apparatus 1520, i.e., at the step S1504, then the verification apparatus 1530 fails in the signature verification after receiving the message.

As an example of processing invalidating the signature, a namespace prefix change and a line feed and space change will be described. First, the namespace prefix change will now be described. The following two XML data will be considered.

(1)
<a:elem xmlns:a=“http://example.org”/>
   (2)
<b:elem xmlns:b=“http://example.org”/>

In (1), “a” is used as the value of the namespace prefix. In (2), “b” is used as the value of the namespace prefix. Except the namespace prefix, (1) and (2) denote the same data. In the Exclusive XML Canonicalization, canonicalization of the namespace prefix is not conducted, and consequently a result of signature on (1) and a result of signature on (2) are different from each other. If, for example, the data (2) is converted to the data (1) at the step 1504, therefore, the signature is invalidated.

The line feed and whitespace change will now be described. The following two XML data will be considered.

(3)
<a>
<b>xyz</b>
</a>
(4)
<a><b>xyz</b></a>

In (3), a line feed exists after a start-tag <a> and before an end-tag </a>. Furthermore, a space exists before a start-tag <b>. In (4), neither a line feed nor a space exists. In the Exclusive XML Canonicalization, canonicalization of the line feed or space in such element contents is not conducted, and consequently a result of signature on (3) and a result of signature on (4) are different from each other. If, for example, the data (3) is converted to the data (4) at the step 1504, therefore, the signature is invalidated.

### SUMMARY OF THE INVENTION

Therefore, an object of the present invention is to prevent a signature from being invalidated when conducting processing on data provided with the signature.

In order to solve the problem, the present invention provides a signature information processing method executed by an information processing apparatus including a processing unit which executes processing on data containing signature information which is information concerning a signature and which processes information, and a storage unit which stores information. The processing unit conducts extraction processing to extract signature information from the data and store the signature information in the storage unit, executes information processing on the data, and then conducts substitution processing to substitute signature information stored in the storage unit for signature information contained in data obtained after execution of the processing.

According to the present invention, it is possible to prevent a signature from being invalidated when conducting processing on data provided with the signature.

Other objects, features and advantages of the invention will become apparent from the following description of the embodiments of the invention taken in conjunction with the accompanying drawings

### BRIEF DESCRIPTION OF THE DRAWINGS

FIG. 1 is a diagram showing a configuration of a system in a first embodiment;

FIG. 2 is a diagram showing a hardware configuration of each of apparatuses shown in FIG. 1;

FIG. 3 is a diagram showing a flow of processing executed by the system shown in FIG. 1;

FIG. 4 is a diagram showing an example of a message provided with a signature;

FIG. 5 is a diagram showing a flow of extraction processing conducted in a signature information extraction unit shown in FIG. 1;

FIG. 6 is a diagram showing an example of information stored in a signed information storage unit shown in FIG. 1;

FIG. 7 is a diagram showing an example of information stored in a referenced element storage unit shown in FIG. 1;

FIG. 8 is a diagram showing an example of a message obtained after processing conducted by a message processing unit shown in FIG. 1;

FIG. 9 is a diagram showing a flow of substitution processing conducted in a signature information substitution unit shown in FIG. 1;

FIG. 10 is a diagram showing an example of a message obtained after substitution processing conducted by the signature information substitution unit shown in FIG. 1;

FIG. 11 is a diagram showing a configuration of a system in a second embodiment;

FIG. 12 is a diagram showing a flow of processing executed by the system shown in FIG. 11;

FIG. 13 is a diagram showing a detailed flow of signature validity verification processing shown in FIG. 12;

FIG. 14 is a diagram showing an example of information stored in a signature validity storage unit shown in FIG. 11; and

FIG. 15 is a diagram showing a flow of processing according to a conventional technique.

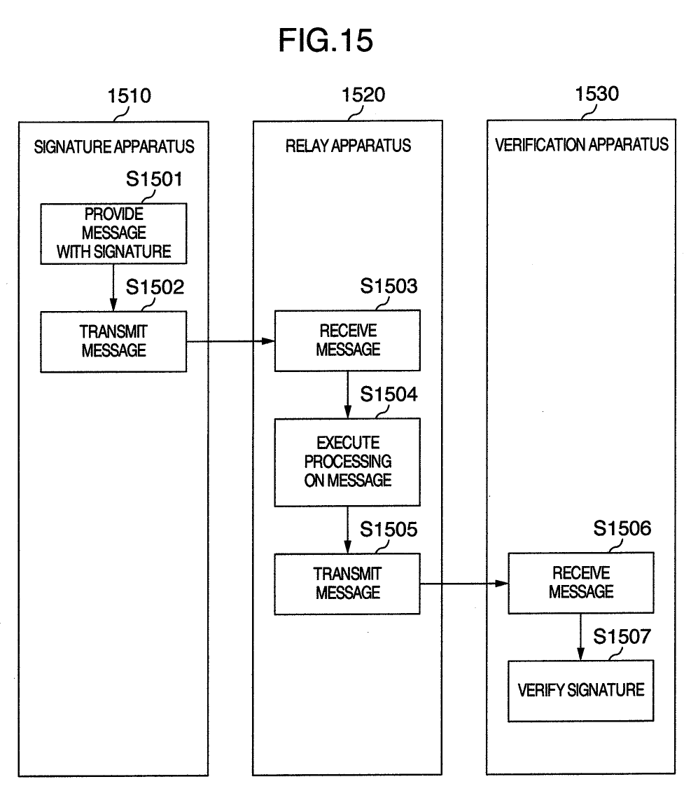

### DETAILED DESCRIPTION OF THE EMBODIMENTS

Hereafter, embodiments of the present invention will be described with reference to the drawings.

### First Embodiment

Hereafter, a first embodiment of the present invention will be described with reference to the drawings.

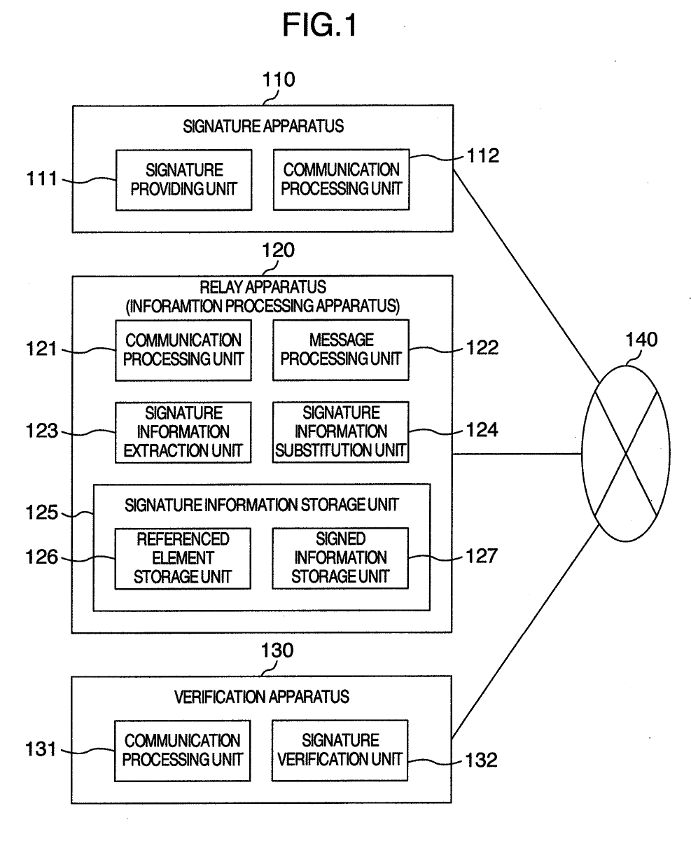

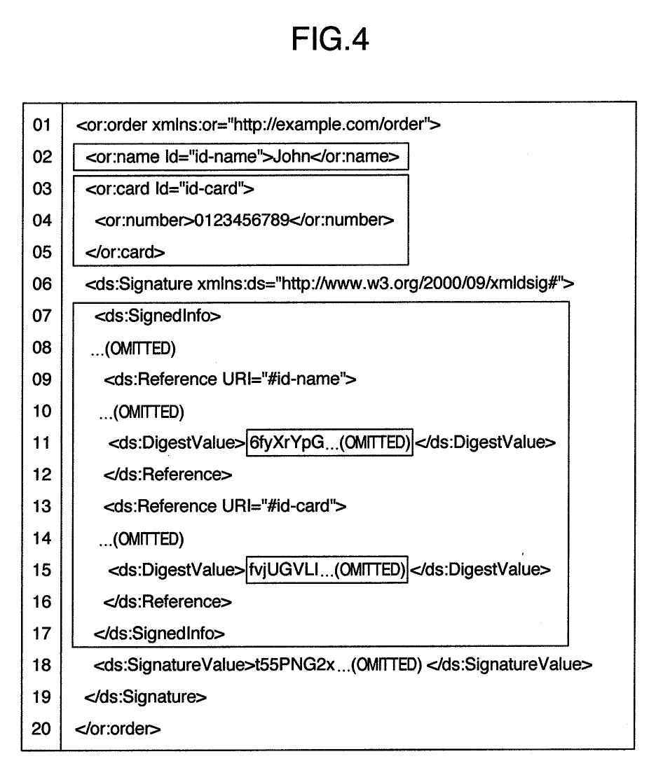

FIG. 1 is a diagram showing a configuration of a system in the first embodiment. In the present system, a signature apparatus 110, a relay apparatus 120 serving as an information processing apparatus, and a verification apparatus 130 are made to be able to communicate to each other via a network 140. Data provided with a signature, i.e., data containing signature information which is information concerning the signature is transmitted to the verification apparatus 130 via the relay apparatus 120. Details of the signature information will be described later with reference to FIG. 4. In the present embodiment, XML data provided with an XML signature is used as an example of data provided with a signature. Hereafter, XML data exchanged between apparatuses is referred to as message as well.

The signature apparatus 110 includes a signature providing unit 111 which provides a message to be transmitted with a signature, and a communication processing unit 112 which conducts message transmission and reception.

The relay apparatus 120 includes a communication processing unit 121 which conducts message transmission and reception, a message processing unit 122 which conducts processing on a received message, a signature information extraction unit 123 which extracts signature information contained in the received message, a signature information substitution unit 124 which substitutes signature information contained in a message to be transmitted, and a signature information storage unit 125 which stores signature information extracted by the signature information extraction unit 123. The signature information storage unit 125 includes a referenced element storage unit 126 which stores a referenced element and a signed information storage unit 127 which stores signed information. Details of the referenced element and the signed information will be described later with reference to FIG. 4. In the present embodiment, a signature information processing method is executed by the signature information extraction unit 123 and the signature information substitution unit 124.

The verification apparatus 130 includes a communication processing unit 131 which conducts a message transmission and a reception, and a signature verification unit 132 which conducts a verification on a signature with which a message is provided.

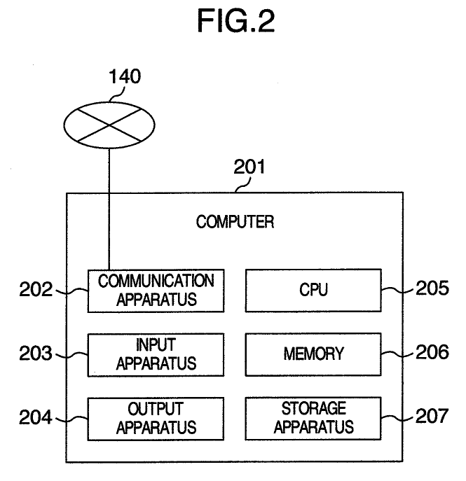

FIG. 2 is a diagram showing a hardware configuration of each of apparatuses shown in FIG. 1. Each of the signature apparatus 110, the relay apparatus 120 and the verification apparatus 130 shown in FIG. 1 can be implemented by using an ordinary computer 201 as shown in FIG. 2.

The computer 201 includes a CPU (Central Processing Unit) 205 serving as a processing unit which conducts processing on information, a memory 206 serving as a storage unit which stores information, a storage apparatus 207 such as a hard disk, an input apparatus 203 such as a keyboard and a mouse, an output apparatus 204 such as a display, and a communication apparatus 202 used for connection to the network. The computer 201 is connected to the network 140 such as, for example, the Internet via the communication apparatus 202. In the computer 201, each function is implemented by the CPU 205 which executes a predetermined program called from the storage unit 207 onto the memory 206.

In the present embodiment, the case where the signature, relay and verification functions are implemented on different computers to serve as the signature apparatus 110, the relay apparatus 120 and the verification apparatus 130 will be described as an example. Alternatively, a plurality of functions among the signature, relay and verification functions may be implemented on the same computer. For example, the relay and verification functions may be implemented on the same computer.

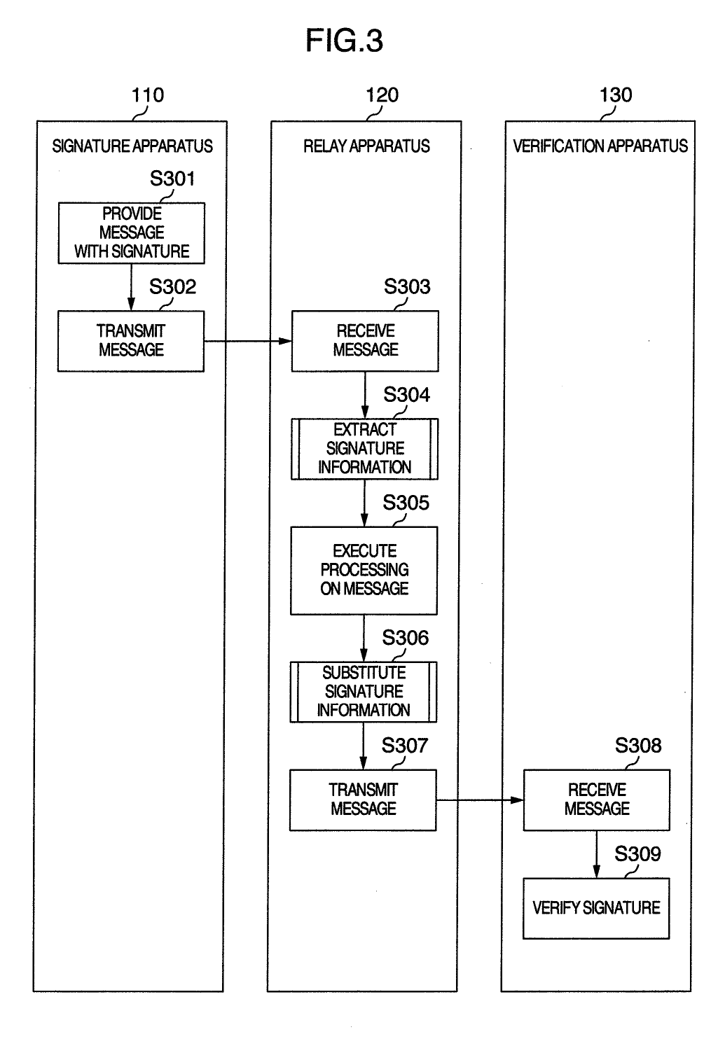

FIG. 3 is a diagram showing a flow of processing executed by the system shown in FIG. 1. Processing executed by the system will now be described with reference to FIG. 3 (and FIGS. 1 and 2 as occasion demands).

In the signature apparatus 110, the signature providing unit 111 provides a message to be transmitted with an XML signature (step S301). The present processing is conducted in the same way as the processing of the XML signature executed ordinarily. The communication processing unit 112 transmits the message provided with the signature to the relay apparatus 120 (Step S302).

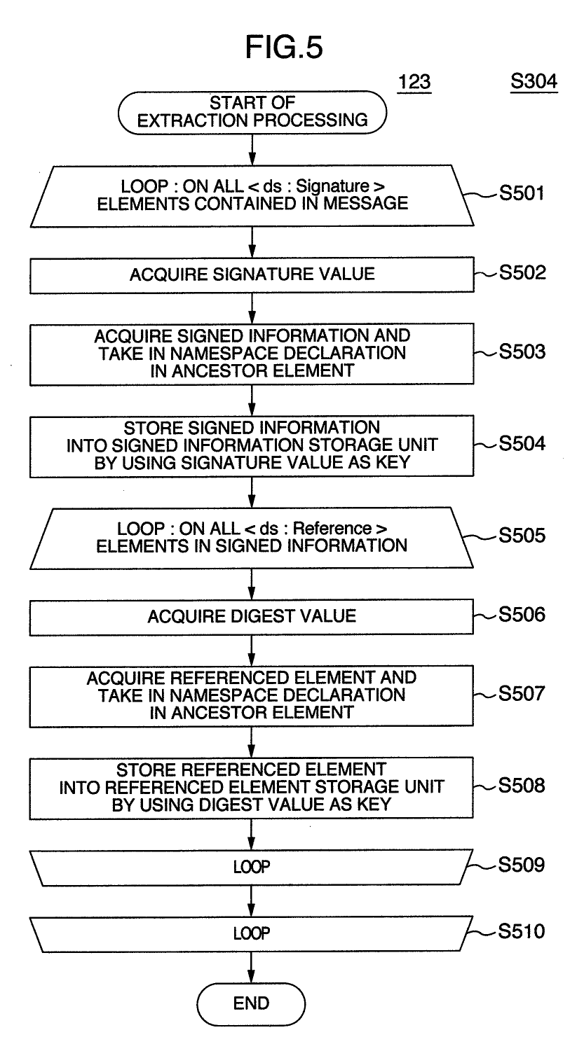

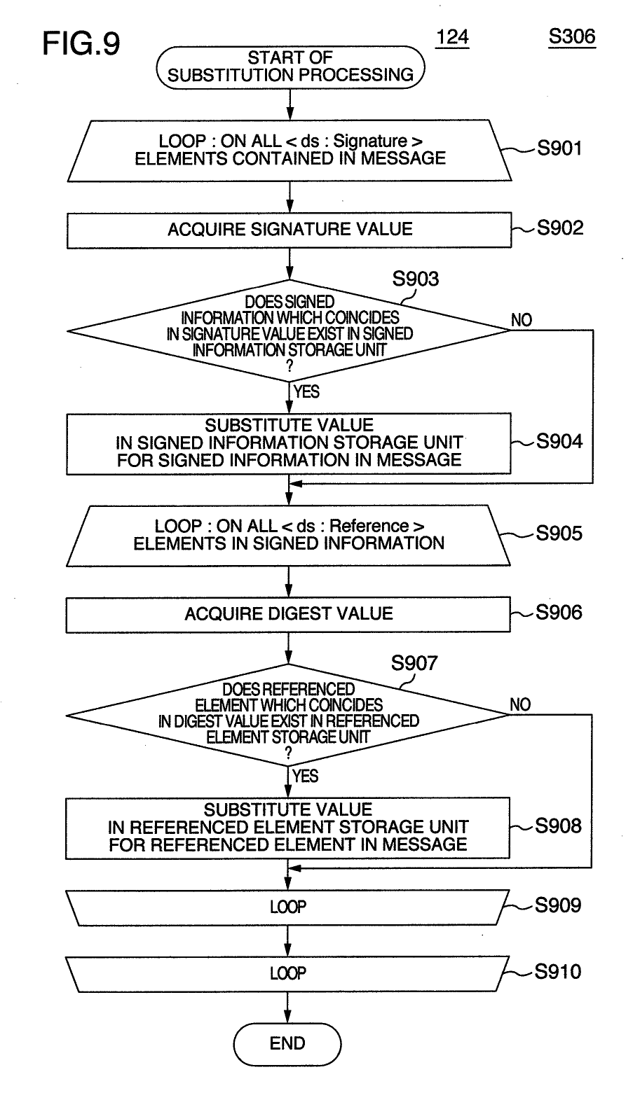

In the relay apparatus 120, the communication processing unit 121 receives the message transmitted from the communication processing unit 112 in the signature apparatus 110 (step S303). The signature information extraction unit 123 extracts signature information contained in the received message, and stores the signature information in the signature information storage unit 125 (step S304). Details of the extraction processing will be described later with reference to FIG. 5. Subsequently, the message processing unit 122 conducts some processing on the message (step S305). And the signature information substitution unit 124 substitutes the signature information stored in the signature information storage unit 125 for the signature information contained in a message to be transmitted (step S306). Details of the substitution processing will be described later with reference to FIG. 9. Subsequently, the communication processing unit 121 transmits the message subjected to the substitution to the verification apparatus 130 (step S307).

In the verification apparatus 130, the communication processing apparatus 131 receives the message transmitted from the communication processing unit 121 in the relay apparatus 120 (step S308). And the signature verification unit 132 verifies the signature with which the received message is provided (step S309).

FIG. 4 is a diagram showing an example of a message provided with an XML signature. The message provided with the XML signature will now be described with reference to FIG. 4 (and FIG. 1 as occasion demands). In the ensuing description, a namespace prefix “ds” is used. It is supposed that the namespace prefix “ds” binds to a namespace URL (Uniform Resource Locator) prescribed in the XML signature.

“Signature information contained in the message” means information concerning the signature. The signature apparatus 110 generates an output value from the signature information on the basis of a predetermined algorithm, and transmits the generated output value and the signature information to the verification apparatus 130 via the relay apparatus 120. The verification apparatus 130 receives the output value and the signature information, generates an output value from the received signature information on the basis of the above-described algorithm, and confirms that the generated output value coincides with the received output value. It is possible to prevent falsification of the signature information owing to such a signature technique.

As for the signature information, there are, for example, signed information and referenced elements. The signed information is information used when calculating a signature value as the output value. The referenced element is information used when calculating a digest value as the output value.

In the example shown in FIG. 4, information (information concerning a name) shown in 02nd line and information (information concerning a card number) shown in 03rd to 05th lines are referenced elements. The signature apparatus 110 generates respective digest values from respective referenced elements, and inserts the respective generated digest values into a message as a digest value shown in an 11th line, for example, 6fyXrYpG . . . (omitted) and a digest value shown in a 15th line, for example, fvjUGVI . . . (omitted).

Information shown in 07th to 17th line is signed information. The signature apparatus 110 generates a signature value from the signed information and inserts the generated signature value into the message as the signature value shown in an 18th line, for example, t55PNG2x . . . (omitted).

FIG. 5 is a diagram showing a flow of extraction processing conducted in the signature information extraction unit 123 shown in FIG. 1. The extraction processing conducted in the signature information extraction unit 123 will now be described with reference to FIG. 5 (and FIGS. 1 to 4 as occasion demands).

The signature information extraction unit 123 conducts signature information extraction processing (steps S502 to S509) described hereafter on all <ds:Signature> elements contained in the received message (step S501). In the signature information extraction processing, the signature information extraction unit 123 acquires contents of <ds:SignatureValue> element contained in <ds:Signature> element which is the object, as a signature value (step S502). In the case of the message example shown in FIG. 4, the signature value becomes “t55PNG2x . . . (omitted)”. Subsequently, the signature information extraction unit 123 acquires signed information (for example, <ds:SignedInfo> element) contained in the <ds:Signature> element and takes a necessary namespace declaration declared in an ancestor element of the signed information into the acquired signed information (step S503). The processing of taking in the namespace declaration declared in the ancestor element is executed ordinarily as a part of the processing described in John Boyer et al., “Exclusive XML Canonicalization”, (online), Jul. 18, 2002, W3C, (retrieved on Dec. 8, 2006), Internet <URL:http://www.w3.org/TR/2002/REC-xml-exc-c14n-20020718/>). In the case of the message example shown in FIG. 4, the signed information obtained after the namespace declaration in the ancestor element is taken in becomes as follows:

```
<ds:SignedInfo xmlns:ds=“http://www.w3.org/2000/09/xmldsig#”>
... (omitted)
    <ds:Reference URI=“#id-name”>
... (omitted)
      <ds:DigestValue>6fyXrYpG.. (omitted) </ds:DigestValue>
    </ds:Reference>
    <ds:Reference URI=“#id-card”>
    ... (omitted)
      <ds:DigestValue>fvjUGVLI.. (omitted)</ds:DigestValue>
    </ds:Reference>
  </ds:SignedInfo>
```

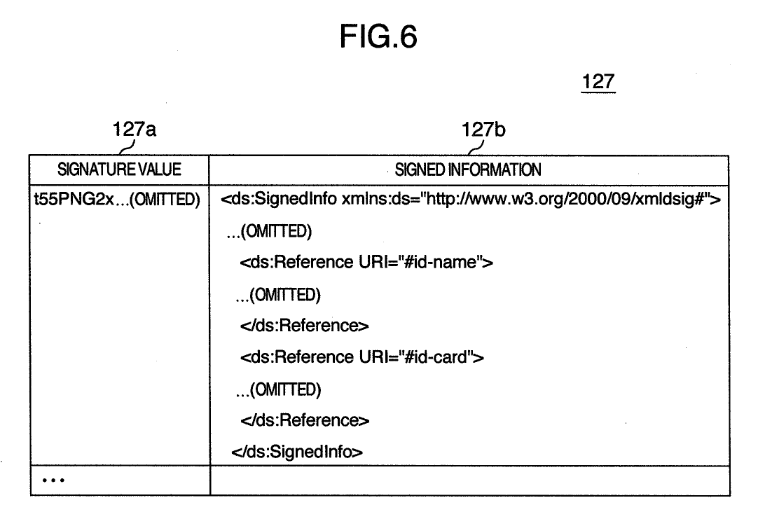

Subsequently, the signature information extraction unit 123 stores the signed information acquired at the step S503 into the signed information storage unit 127 by using the signature value acquired at the step S502 as a key (step S504). The signed information is stored in the signed information storage unit 127 in the state in which the namespace declaration is taken in. The signature value and the signed information are associated with each other respectively as a signature value 127a (see FIG. 6) and signed information 127b (see FIG. 6), and stored in the signed information storage unit 127 (see FIG. 6).

Subsequently, the signature information extraction unit 123 conducts referenced element acquisition processing (steps S506 to S508) described hereafter on all <ds:Reference> elements in the signed information (step S505). In the referenced element acquisition processing, the signature information extraction unit 123 acquires contents of the <ds:DigestValue> element contained in the <ds:Reference> element which is the object, as a digest value (step S506). In the case of the <ds:Reference> element (09th to 12th) which appears first in the message example shown in FIG. 4, the digest value becomes “6fyXrYpG . . . (omitted)”.

Subsequently, the signature information extraction unit 123 acquires a referenced element for the <ds:Reference> element which is the object, and takes necessary namespace declarations declared in an ancestor element of the acquired referenced element into the acquired referenced element (step S507). In the case of the <ds:Reference> element (09th to 12th) which appears first in the message example shown in FIG. 4, the <ds:Reference> element has a UR1=“#id-name” attribute. This represents that an element having an attribute which has a value “id-name” as the value of the Id attribute is referenced in the same XML data. Therefore, the referenced element is an <or:name> element. In this way, the <or:name> element is acquired, and a namespace declaration declared in an ancestor element of the <or:name> element is taken in. A referenced element obtained after the namespace declaration declared in the ancestor element is taken in becomes as follows:
<or:name Id=“id-name” xmlns:or=“http://example.com/order”>John</or:name>

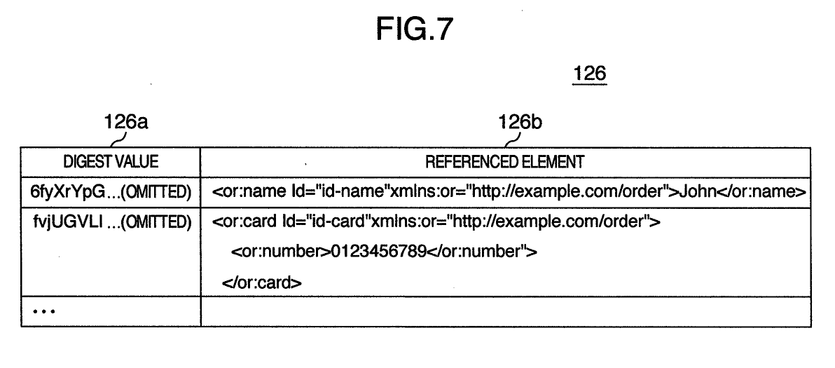

Subsequently, the signature information extraction unit 123 stores the referenced element acquired at the step S507 into the referenced element storage unit 126 by using the digest value acquired at the step S506 as a key (step S508). The referenced element is stored in the referenced element storage unit 126 in the state in which the namespace declaration is taken in. The digest value and the referenced element are associated with each other respectively as a digest value 126a (see FIG. 7) and a referenced element 126b (see FIG. 7), and stored in the referenced element storage unit 126 (see FIG. 7).

Upon arriving at an end of loop processing (step S509), the signature information extraction unit 123 returns to the step S505 and repeats the loop processing. Upon finishing the loop processing started at the step S505 and arriving at an end of the loop processing (step S510), the signature information extraction unit 123 returns to the step S501 and repeats the loop processing. Upon finishing the loop processing started at the step S501, the signature information extraction unit 123 finishes the extraction processing.

FIG. 6 is a diagram showing an example of information stored in the signed information storage unit 127 shown in FIG. 1. As shown in FIG. 6, information stored in the signed information storage unit 127 is obtained by associating the signature value 127a and the signed information 127b with each other.

FIG. 7 is a diagram showing an example of information stored in the referenced element storage unit 126 shown in FIG. 1. As shown in FIG. 7, information stored in the referenced element information storage unit 126 is obtained by associating the digest value 126a and the referenced element information 126b with each other.

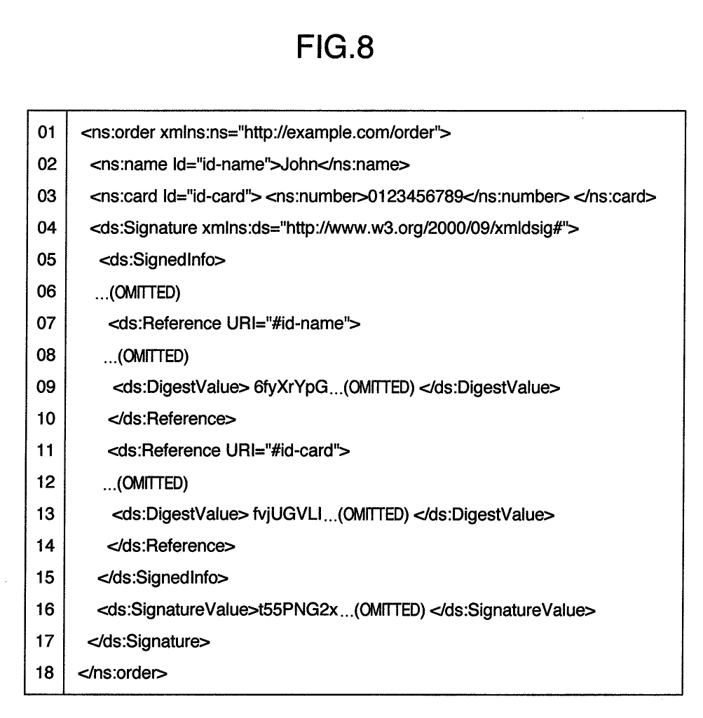

FIG. 8 is a diagram showing an example of a message obtained after processing conducted by the message processing unit 122 shown in FIG. 1. The message obtained after the processing will now be described with reference to FIG. 8 (and FIG. 1 as occasion demands).

The message processing unit 122 conducts predetermined processing on a message. In other words, a message (see FIG. 4) obtained before the processing conducted by the message processing unit 122 is different in message form from a message (see FIG. 8) obtained after the processing. As shown in FIG. 8, for example, a namespace prefix bound to a namespace URI “http://example.com/order” is changed from “or” to “ns”. Furthermore, for example, in the message before the processing (see FIG. 4), line feeds and spaces are contained in a <or:card> element. In the message after the processing (see FIG. 8), however, neither a line feed nor a space is contained in a <ns:card> element. Because of these changes, digest values and a signature value calculated from the message after the processing (see FIG. 8) are different from digest values and a signature value inserted into the message before the processing (see FIG. 4). In the message after the processing (see FIG. 8), therefore, the signature is invalidated.

FIG. 9 is a diagram showing a flow of substitution processing conducted in the signature information substitution unit 124 shown in FIG. 1. The substitution processing conducted in the signature information substitution unit 124 will now be described with reference to FIG. 9 (and FIGS. 1 to 8 as occasion demands).

The signature information substitution unit 124 conducts signature information substitution processing (steps S902 to S909) described hereafter on all <ds:Signature> elements contained in a message to be transmitted (step S901). In the signature information substitution processing, the signature information substitution unit 124 acquires contents of a <ds:SignatureValue> element contained in a <ds:Signature> element which is the object, as a signature value (step S902).

Subsequently, the signature information substitution unit 124 makes a decision whether signed information (for example, a <ds:SignedInfo> element) having a signature value which coincides with the signature value acquired at the step S902 exists in the signed information storage unit 127 (step S903). If signed information having a coincident signature value exists in the signed information storage unit 127 (“yes” at the step S903), the signature information substitution unit 124 substitutes the value in the signed information storage unit 127 for the signed information in the message (step S904). In other words, the signature information substitution unit 124 acquires the signed information 127b associated with the signature value 127a which coincides with the signature value acquired at the step S902, from the signed information storage unit 127, and substitutes the acquired signed information 127b for the signed information confirmed as regards existence at the step S903. If signed information the signature value of which coincides with the obtained signature value does not exist in the signed information storage unit 127 (“no” at the step S903), the processing proceeds to the step S905.

Subsequently, the signature information substitution unit 124 conducts referenced element substitution processing (steps S906 to S908) described hereafter on all <ds:Reference> elements in the signed information containing the signature value acquired at the step S902 (step S905). In the referenced element substitution processing, the signature information substitution unit 124 acquires contents of a <ds:DigestValue> element contained in a <ds:Reference> element which is the object, as a digest value (step S906). Subsequently, the signature information substitution unit 124 makes a decision whether a referenced element having a digest value which coincides with the digest value acquired at the step S906 exists in the referenced element storage unit 126 (step S907). If a referenced element having a coincident digest value exists in the referenced element storage unit 126 (“yes” at the step S907), the signature information substitution unit 124 substitutes the value in the referenced element storage unit 126 for the referenced element in the message (step S908). In other words, the signature information substitution unit 124 acquires the referenced element 126b associated with the digest value 126a which coincides with the digest value acquired at the step S906, from the referenced element storage unit 126, and substitutes the acquired referenced element 126b for the referenced element confirmed as regards existence at the step S907. If a referenced element the digest value of which coincides with the acquired digest value does not exist in the referenced element storage unit 126 (“no” at the step S907), the processing proceeds to the step S909.

Upon arriving at an end of loop processing (step S909), the signature information substitution unit 124 returns to the step S905 and repeats the loop processing. Upon finishing the loop processing started at the step S905 and arriving at an end of the loop processing (step S910), the signature information substitution unit 124 returns to the step S901 and repeats the loop processing. Upon finishing the loop processing started at the step S901, the signature information substitution unit 124 finishes the substitution processing.

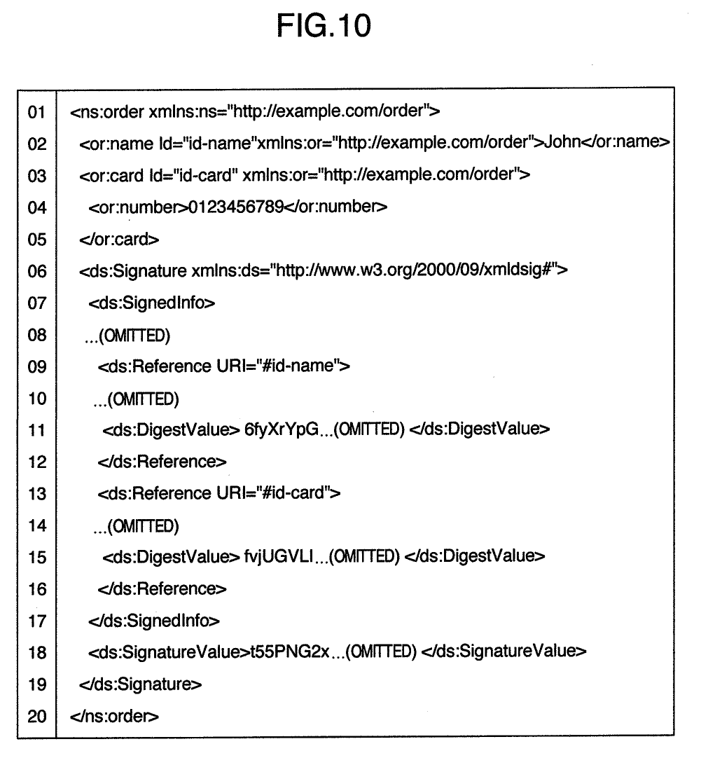

FIG. 10 is a diagram showing an example of a message obtained after the substitution processing is conducted by the signature information substitution unit 124 shown in FIG. 1. The message obtained after the substitution processing will now be described with reference to FIG. 10 (and FIG. 1 as occasion demands).

The communication processing unit 121 in the relay apparatus 120 transmits the message (see FIG. 10) obtained after the substitution processing is conducted to the verification apparatus 130. The transmitted message is received by the communication processing unit 131 in the verification apparatus 130. The signature verification unit 132 in the verification apparatus 130 verifies an XML signature contained in the received message by using a technique executed on the ordinary XML signature (for example, a verification technique using the verification apparatus 130 described with reference to FIG. 4). In the message received by the verification apparatus 130, the validity of the signature is maintained as shown in FIG. 10. In the signature verification unit 132, therefore, the signature verification succeeds.

Thus, in the present embodiment, the signature information extraction unit 123 in the relay apparatus 120 conducts extraction processing of extracting signature information from data and storing the extracted signature information in the signature information storage unit 125, and the message processing unit 122 executes the processing on the data and then conducts substitution processing of substituting signature information stored in the signature information storage unit 125 for signature information contained in the data. Even if processing which invalidates the signature is conducted in the processing conducted by the relay apparatus 120, therefore, the state before the validity of the signature is impaired can be restored. As a result, it is possible to prevent the signature from being invalidated when conducting processing on the data provided with the signature.

The present invention can be applied widely in a system using a signature. For example, when transferring travel reservation information provided with a signature to a travel agency, a travel wholesaler, a lodging facility or the like in a travel reservation system, there is a possibility that a signature might be invalidated. Data such as reservation information can be transferred while ensuring the validity of the signature by applying the present invention to the travel reservation system. For example, information life cycle management in which optimum data arrangement is conducted by moving data according to the life cycle of information is under study. When moving data provided with a signature in the information life cycle management, there is a possibility that the signature will be invalidated. It becomes possible to arrange data while ensuring the validity of the signature by applying the present invention to the information life cycle management.

### Second Embodiment

Hereafter, a second embodiment of the present invention will be described with reference to the drawings.

Information systems in recent years are often constructed by utilizing various services opened to the public on the network. In such systems, there is a possibility that processing which invalidates the signature will be conducted in the utilized service.

Even if processing which invalidates the signature is conducted by using the method described in the first embodiment, it becomes possible to ensure the signature validity. If a place where the signature is invalidated cannot be known when a plurality of services are present, it is impossible to discriminate the place where the extraction processing or the substitution processing described in the first embodiment should be executed. In the present embodiment, a technique for ensuring the signature validity over the whole system by detecting a place where the signature is invalidated and utilizing the technique described in the first embodiment when constructing a system by utilizing various services will be described.

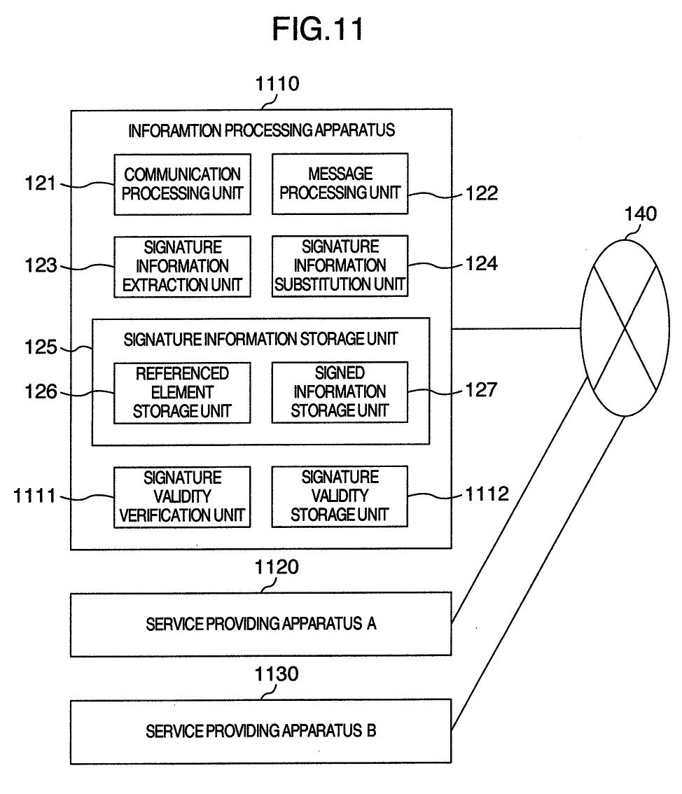

FIG. 11 is a diagram showing a configuration of a system in the second embodiment. As shown in FIG. 11, the present system includes an information processing apparatus 1110, a service providing apparatus A (1120), and a service providing apparatus B (1130). Although the case where there are two service providing apparatuses will be described as an example, the number of service providing apparatuses is not especially restricted. Data (for example, XML data) are exchanged between apparatuses. The XML data (message) sometimes has a provided XML signature therewith. In the present embodiment, for example, it is supposed that an administrator who constructs or operates the information processing apparatus 1110 detects a place where the signature is invalidated, as a situation. The present embodiment is especially effective in a situation in which the administrator does not grasp processing conducted within the service providing apparatus A 1120 and the service providing apparatus B 1130 when constructing the system.

The information processing apparatus 1110 includes a communication processing unit 121, a message processing unit 122, a signature information extraction unit 123, a signature information substitution unit 124, a signature information storage unit 125, a signature validity verification unit 1111, and a signature validity storage unit 1112. The communication processing unit 121, the message processing unit 122, the signature information extraction unit 123, the signature information substitution unit 124, and the signature information storage unit 125 are the same as those described in the first embodiment. In the present embodiment, a signature information processing method is executed by the signature validity verification unit 1111 in addition to the signature information extraction unit 123 and the signature information substitution unit 124 which have the same configurations as those in the first embodiment.

The information processing apparatus 1110 executes one business process by utilizing the services provided by the service providing apparatus A 1120 and the service providing apparatus B 1130. If the service provided by the service providing apparatus A 1120 is utilized, a message is transmitted from the information processing apparatus 1110 to the service providing apparatus A 1120. The service providing apparatus A 1120 conducts some processing on the received message, and then returns the message to the information processing apparatus 1110. The message to be transmitted from the information processing apparatus 1110 and the message to be returned from the service providing apparatus A 1120 is sometimes provided with an XML signature.

If the message to be transmitted from the information processing apparatus 1110 is provided with an XML signature, there is a possibility that the XML signature will be invalidated at the time of processing conducted in the service providing apparatus A 1120. In that case, the message returned from the service providing apparatus A 1120 is sometimes provided with an invalidated XML signature. In the same way as the first embodiment, processing which invalidates the XML signature is sometimes executed in the message processing unit 122 in the service providing apparatus A 1120. Thus, when executing a business process in the information processing apparatus 1110 by utilizing service provided by a service providing apparatus, there is a possibility that the signature will be invalidated in the service providing apparatus, the information processing apparatus 1110 or the like.

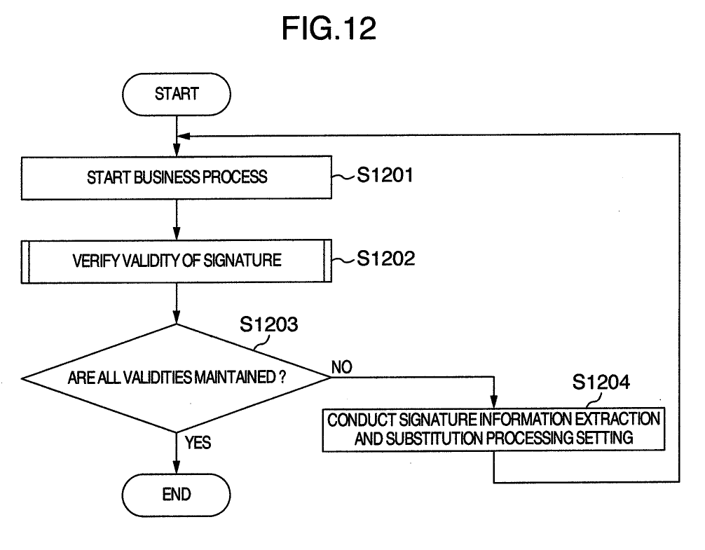

FIG. 12 is a diagram showing a flow of processing executed by the system shown in FIG. 11. The processing executed by the system will now be described with reference to FIG. 12 (and FIG. 11 as occasion demands). By the way, it is supposed that the processing described hereafter is executed mainly at the time of construction of the system. In the present system, the information processing apparatus 1110 implements one business process by utilizing the services providing apparatus A 1120 and the service providing apparatus B 1130 as described above.

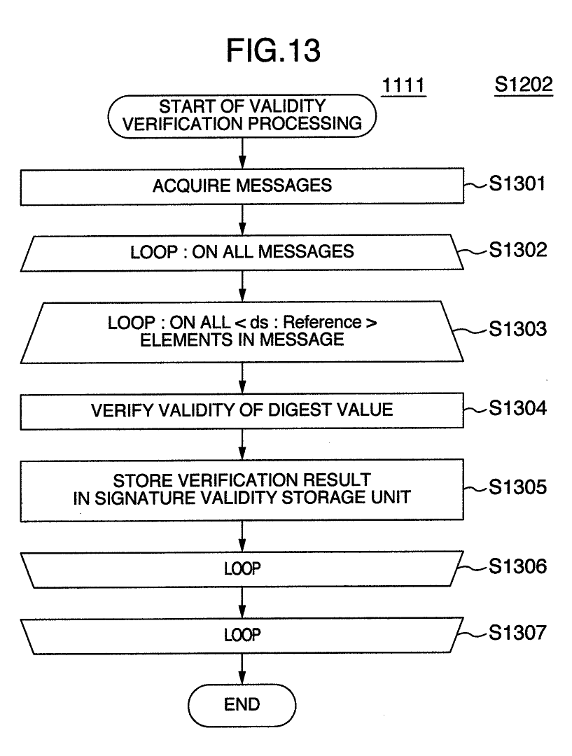

First, for example, an administrator of the system transmits test data to the information processing apparatus 1110 via a terminal (not illustrated). As a result, the communication processing unit 121 receives the test data, and the signature validity verification unit 1111 starts a business process on the basis of the test data received by the communication processing unit 121 (step S1201). When executing the business process, the signature validity verification unit 1111 verifies the validity of the signature as regards all messages exchanged between apparatuses (step S1202). Details of verification of the signature validity will be described later with reference to FIG. 13.

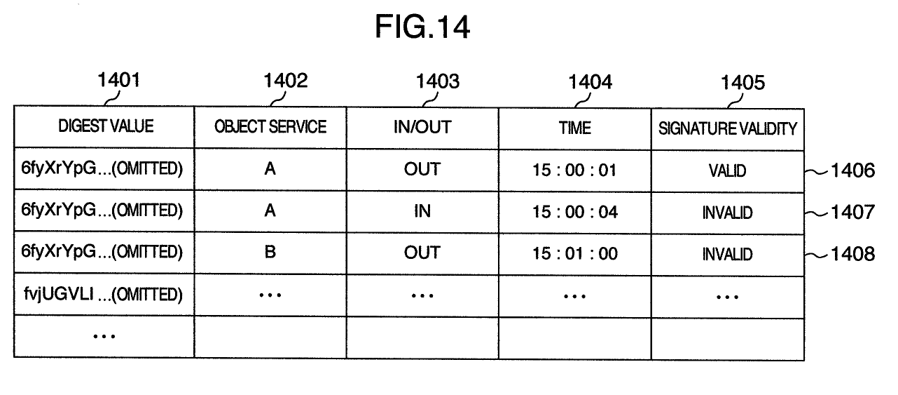

The signature validity verification unit 1111 makes a decision whether all validities are maintained (step S1203). If all validities are maintained (“yes” at the step S1203), the present processing is finished. If there is a message in which the validity is not maintained (“no” at the step S1203), the signature validity verification unit 1111 conducts signature information extraction and substitution processing setting on a message in which the validity is not maintained (step S1204) and returns to the step S1201. As for a message subjected to the signature information extraction and substitution processing setting at the step S1204, there is a possibility that the signature information extraction and substitution processing will be executed and changed to a form in which the signature validity is maintained, by the next business process started at the step S1201. The message subjected to the signature information extraction and substitution processing setting may be all or a selected part of the message in which the validity is not maintained. Efficient selection of a message to be subjected to the signature information extraction and substitution processing setting will be described later with reference to FIG. 14.

FIG. 13 is a diagram showing a detailed flow of the signature validity verification processing (step S1202) shown in FIG. 12. The signature validity verification processing will now be described with reference to FIG. 13 (and FIG. 11 as occasion demands).

First, the signature validity verification unit 1111 acquires all messages exchanged between apparatuses (step S1301). And the signature validity verification unit 1111 conducts processing (steps S1303 to S1306) for verifying the validity of a message on all acquired messages (step S1302). In the message validity verifying processing, validity verification result acquisition processing (steps S1304 and S1305) is conducted on all <ds:Reference> elements contained in the acquired messages (step S1303). In the validity verification result acquisition processing, the signature validity verification unit 1111 first acquires a digest value (contents of a <ds:DigestValue> element) in a <ds:Reference> element, acquires a referenced element for the <ds:Reference> element which is the object, and calculates and acquires a digest value from the referenced element. The signature validity verification unit 1111 verifies whether two digest values thus acquired coincides with each other (step S1304). This verification processing is processing which is ordinarily executed as a part of ordinary XML signature verification processing. The signature validity verification unit 1111 stores a result of the verification in the signature validity storage unit 1112 (step S1305).

Upon arriving at an end of loop processing (step S1306), the signature validity verification unit 1111 returns to the step S1303 and repeats the loop processing. Upon finishing the loop processing started at the step S1303 and arriving at an end of the loop processing (step S1307), the signature validity verification unit 1111 returns to the step S1302 and repeats the loop processing. Upon finishing the loop processing started at the step S1302, the signature validity verification unit 1111 finishes the signature validity verification processing.

FIG. 14 is a diagram showing an example of information stored in the signature validity storage unit 1112 shown in FIG. 11. The information stored in the signature validity storage unit 1112 will now be described with reference to FIG. 14 (and FIG. 11 as occasion demands).

As for information to be stored in the signature validity storage unit 1112, it is stored by the signature validity verification unit 1111 at the step S1305 (see FIG. 13). In the information stored in the signature validity storage unit 1112, a digest value 1401, information concerning a place where a message to be verified is acquired, time 1404, and signature validity 1405 are associated.

The digest value 1401 is a digest value contained in the message as contents of a <ds:DigestValue> element.

As the information concerning a place where a message to be verified is acquired, for example, an object service 1402 and IN/OUT 1403 can be used. For example, if the object service 1402 is “A”, it is indicated that messages exchanged between the information processing apparatus 1110 and the service providing apparatus A 1120 have been acquired. As the object service 1402, information which can uniquely identify a service providing apparatus, such as identification information, an IP address or a URL of the service providing apparatus, can be used. If the “IN/OUT” 1403 is “OUT”, it is indicated that a message to be transmitted from the information processing apparatus 1110 has been acquired. If the “IN/OUT” 1403 is “IN”, it is indicated that a message to be received by the information processing apparatus 1110 has been acquired.

The time 1404 is time when the message has been acquired.

The signature validity 1405 is a result of signature validity verification executed at the step S1304. In other words, the signature validity verification unit 1111 stores “valid” in the signature validity 1405 when the two digest values coincide with each other, whereas the signature validity verification unit 1111 stores “invalid” in the signature validity 1405 when the two digest values do not coincide with each other, at step S1304.

In this way, the signature validity verification unit 1111 verifies signature validity as regards all messages exchanged between the information processing apparatus 1110 and the service providing apparatuses. If the signature is valid as regards all messages as a result of the validity verification, i.e., if the signature validity verification unit 1111 judges all data in the signature validity 1405 in the signature validity storage unit 1112 to be “valid” at the step S1203, then the processing shown in FIG. 12 is finished. In this case, it is indicated that a place where processing which invalidates the signature is conducted does not exist in the business process. On the other hand, if an invalid signature is included, i.e., if the signature validity verification unit 1111 judges that “invalid” is included in the signature validity 1405 in the signature validity storage unit 1112 at the step S1203, then it is indicated that processing which invalidates the signature exists. In this case, signature validity can be ensured by conducting the signature information extraction and substitution processing according to the method described in the first embodiment.

If “invalid” is included in the signature validity 1405, then it is desirable that the signature validity verification unit 1111 selects a message having the same digest value 1401 as a digest value 1401 of data which is “invalid” in the signature validity 1405 and located in a place where the signature validity is “valid”, as a message to be subjected to signature information extraction processing. In the case of the example in the signature validity storage unit 1112 shown in FIG. 14, the signature validity 1405 is “invalid” in data 1407 and data 1408. Both the data 1407 and the data 1408 are “6fyXrYpG . . . (omitted)” in the digest value 1401. Therefore, signature information extraction processing is conducted in a place indicated by data 1406 which is “6fyXrYpG . . . (omitted)” in the digest value 1401 and “valid” in the signature validity 1405. In other words, since the object service 1402 is “A” and the IN/OUT 1403 is “OUT” in the data 1406, it is set so as to conduct the signature information extraction processing described in the first embodiment on a message to be transmitted from the information processing apparatus 1110 to the service providing apparatus A 1120.

If “invalid” is included in the signature validity 1405, it is desirable that the signature validity verification unit 1111 selects a message located in a place which is the earliest in the time 1404 among places where the signature validity 1405 is “invalid”, as a message to be subjected to the signature information substitution processing. In the case of the example in the signature validity storage unit 1112 shown in FIG. 14, the signature validity 1405 is “invalid” in the data 1407 and the data 1408. However, the data 1407 has an earlier time 1404. Therefore, it is set to conduct signature information substitution processing in a place indicated by the data 1407. In other words, since the object service is “A” and the IN/OUT 1403 is “IN” in the data 1407, it is set to conduct signature information substitution processing described in the first embodiment, in a message to be transmitted from the service providing apparatus A 1120 to the information processing apparatus 1110.

After the setting for the signature information extraction processing and substitution processing is conducted as described above, the business process is started by, for example, transmitting test data to the information processing apparatus 1110 again, and the signature validity is verified. The signature validity verification unit 1111 repeats the step S1204, the step S1201 and the step S1202 until it judges all data in the signature validity 1405 in the signature validity storage unit 1112 to be “valid” at the step S1203.

In this way, the signature validity verification unit 1111 can detect places where the signature is valid and places where the signature is invalid by verifying the signature validity in a plurality of places in a business process (for example, by verifying the signature validity in messages exchanged between apparatuses), and can conduct signature information extraction processing in places where the signature is valid and signature information substitution processing in places where the signature is invalid. Furthermore, suitable setting for signature information extraction and substitution processing can be conducted by adding the configuration of the relay apparatus 120 described in the first embodiment to the signature validity verification unit 1111.

In the present embodiment, the case where the digest value is verified when verifying the signature validity has been described as an example. When verifying the signature validity, the signature value verification may be conducted in addition to the digest value verification.

In the present embodiment, the signature validity verification is conducted on messages exchanged between apparatuses. Alternatively, the signature validity verification may be conducted in a different place. For example, the signature validity verification may be conducted in the middle of processing in the message processing unit 122 in the information processing apparatus 1110.

In the present embodiment, information of the object service 1402 and the IN/OUT 1403 is used as information which represents a place where the message has been acquired. Alternatively, the place where the message has been acquired may be represented by different information. For example, processing in the message processing unit 122 is sometimes described as a business process. As a language for describing such a business process, there is, for example, BPEL4WS (Business Process Execution Language for Web Service). The business process is formed of activities each having a plurality of steps. If processing in the message processing unit 122 is thus described as a business process, then the signature validity verification may be conducted before and after each of activities included in the business process.

In the present embodiment, information of the object service 1402 and the IN/OUT 1403 is used as information which represents a place where the message has been acquired. If the signature validity verification is conducted before and after the activity in the message processing unit 122, however, the place where the message has been acquired may be represented by using an identifier which identifies the activity.

It should be further understood by those skilled in the art that although the foregoing description has been made on embodiments of the invention, the invention is not limited thereto and various changes and modifications may be made without departing from the spirit of the invention and the scope of the appended claims.

1. A signature information processing method executed by an information processing apparatus, the information processing apparatus including a processing unit which executes processing on data containing signature information which is information concerning a signature, and a storage unit which stores information,
wherein the processing unit:
conducts extraction processing to extract signature information from the data and store the signature information in the storage unit;
executes information processing on the data; and then
conducts substitution processing to substitute signature information stored in the storage unit for signature information contained in data concerning execution of the information processing.

2. The signature information processing method according to claim 1, wherein if signed information is contained in the data as the signature information, the processing unit:
extracts signed information from the data and stores the signed information in the storage unit;
executes information processing on the data; and then
substitutes signed information stored in the storage unit for signed information contained in data concerning execution of the information processing.

3. The signature information processing method according to claim 2, wherein the processing unit:
extracts signed information from the data and extracts a signature value from the data; and
stores the extracted signed information and signature value in the storage unit so as to associate the extracted signed information and signature value with each other, and
when substituting signed information contained in the data, the processing unit:
acquires signed information associated with a signature value which coincides with a signature value contained in the data, from the storage unit; and
substitutes the acquired signed information for signed information contained in the data.

4. The signature information processing method according to claim 1, wherein if a referenced element is contained in the data as the signature information, the processing unit:
extracts a referenced element from the data and stores the referenced element in the storage unit;
executes processing on the data; and then
substitutes the referenced element stored in the storage unit for a referenced element contained in data concerning execution of the information processing.

5. The signature information processing method according to claim 4, wherein the processing unit:
extracts referenced elements from the data and extracts digest values from the data; and
stores the extracted referenced elements and digest values in the storage unit so as to associate the extracted referenced elements and digest values with each other, and
when substituting referenced elements contained in the data, the processing unit:
acquires referenced elements associated with digest values which coincide with digest values contained in the data, from the storage unit; and
substitutes the acquired referenced elements for referenced elements contained in the data.

6. A signature information processing method for verifying validity of a signature by using an information processing apparatus including a processing unit which conducts processing on information and a storage unit which stores information,
wherein the processing unit detects places where the signature is valid and places where the signature is invalid by verifying signature validity in a plurality of places in a business process.

7. The signature information processing method according to claim 1, wherein the processing unit:
detects places where the signature is valid and places where the signature is invalid by verifying signature validity in a plurality of places in a business process;
conducts the extraction processing in places where the signature is valid; and
conducts the substitution processing in places where the signature is invalid.

8. The signature information processing method according to claim 7, wherein the processing unit repeats processing of conducting setting to conduct the substitution processing in a place where data acquisition time is earliest among places where a signature is invalid and processing of executing the business process again, until a signature becomes valid in all places.

9. A program which causes a computer to execute the signature information processing method according to claim 1.

10. An information processing apparatus comprising a processing unit which executes processing on data containing signature information, which is information concerning a signature, and which processes information, and a storage unit which stores information,
wherein the processing unit:
conducts extraction processing to extract signature information from the data and store the signature information in the storage unit;
executes information processing on the data; and then
conducts substitution processing to substitute signature information stored in the storage unit for signature information contained in data concerning execution of the information processing.
